(19) United States
(12) Patent Application Publication
(10) Pub. No.: US 2026/0321230 A1
(43) Pub. Date: Oct. 15, 2026

(54) GESTURE-BASED DIGITAL ARTIST WORKSTATION TOOL

(71) Applicant: Tamber, Inc., Los Angeles, CA (US)

(72) Inventor: Zoe Mirkovich, Los Angeles, CA (US)

(21) Appl. No.: 19/641,158

(22) Filed: Apr. 7, 2026

Related U.S. Application Data
(60) Provisional application No. 63/785,929, filed on Apr. 9, 2025.

(51) Int. Cl. G10H 1/00

(52) U.S. Cl. CPC G10H 1/0008; G10H 2220/201

(57) ABSTRACT

A gesture music system configured to control a digital artist workstation using music protocol commands based on gestures and movements made by a user is disclosed herein. The gesture music system receives a frame of image data depicting a gesture performed by a user. The gesture music system inputs the frame to a machine learning model configured to identify gestures. The gesture music system accesses a grid including a first axis corresponding to a first musical setting and a second axis corresponding to a second musical setting. The gesture music system determines a location of the gesture on the grid. The gesture music system creates a music protocol command corresponding to the first musical setting and second musical setting. The gesture music system sends the music protocol command to a digital music workstation to cause the user device to output a musical sound.

### CROSS REFERENCE TO RELATED APPLICATIONS

This application claims the benefit of U.S. Provisional Patent Application Ser. No. 63/785,929, filed Apr. 9, 2025, which is incorporated by reference herein in its entirety.

### BACKGROUND

Digital Music Workstations, also known as Digital Audio Workstations (DAWs), are software platforms used for recording, editing, producing, and mixing digital audio and music. DAWs offer a wide array of tools for sequencing, arranging, sound design, and real-time audio manipulation. Popular DAWs include Ableton Live, FL Studio, Logic Pro, Pro Tools, and Cubase. These platforms support multitrack recording and provide extensive libraries of virtual instruments, audio effects, and plugins, making them a central hub for modern music production.

A core component of digital music workstations is their integration with music protocol commands (e.g., Musical Instrument Digital Interface (MIDI)). Music protocol commands enable electronic musical instruments, computers, and other equipment to communicate and synchronize with each other. Unlike audio signals, music protocol commands do not transmit sound but rather transfer performance data such as: note on/off, which indicates when a key is pressed or released; velocity, which measures how hard a note is played; pitch bend, which alters the pitch of a note smoothly; control change, which sends real-time control data such as modulation, volume, panning, or expression; and program change, which switches between different instrument sounds or patches.

Within a DAW, music protocol command data can be recorded from protocol controllers (such as keyboards, drum pads, or wind controllers) or programmed manually through piano roll interfaces. The DAW interprets these music protocol commands to trigger virtual instruments or control external hardware synthesizers, allowing for intricate and precise musical arrangements. The ability to edit and manipulate protocol data non-destructively gives producers immense creative control. Notes can be quantized, transposed, or stretched, and protocol automation can be applied to modulate effects and parameters over time. This makes protocol not only a communication tool but also a powerful compositional resource within digital music workstations.

Typically, a user provides music protocol commands to a DAW using an input device such as a soundboard or an instrument capable of converting the user's inputs into music protocol commands. These specialized peripheral devices may include a number of input interfaces that the user physically interacts with (e.g., the strings of a guitar or the keys of a soundboard). MIDI commands may be mapped to these input interfaces using software. These specialized peripheral devices are costly and the user may require several peripherals connected to the DAW to produce their desired music outputs. Furthermore, the user must individually set up the interface between peripherals and the DAW (e.g., connecting a drum machine and a guitar to a DAW).

Similarly, a DAW may be programmed and operated using user interface devices such as a mouse and keyboard configuration. While these peripherals are more commonplace, such a configuration typically requires a fixed workstation and dedicated connections between the peripherals and DAW for each input device. When a user wishes to change input devices (e.g., a keyboard to a macro pad), they must reconfigure the integration between the device and the DAW, including the mapping of physical input devices such as keys. Therefore, there exists a technical challenge of controlling a DAW without the use of specialized or numerous peripheral input devices.

### SUMMARY

In accordance with one or more aspects of the disclosure, a gesture music system addresses the technical challenge of controlling a DAW without the use of specialized or numerous peripheral devices using an image-based machine learning model. The gesture music system receives frames of image data depicting a user making gestures, where the user's gestures represent intended inputs to the DAW. The gesture music system identifies gestures made by a user depicted in image data using a machine learning model. The machine learning model is capable of mapping identified gestures to music protocol commands in real-time based on a user's predetermined mapping preferences. Because the user's preferences are configured within the gesture music system, the user does not have to change between peripheral devices and manage the interfaces between peripheral devices and the DAW.

After a user's mapping preferences are established, the user is able to control a DAW using music protocol commands mapped to their gestures. The user may change configurations (e.g., switching instruments) and finely control the input to the DAW based using gestures. Parameters of the music protocol command may be adjusted based on the relative location of a gesture in a frame of view input to the machine learning model. For example, the volume associated with a music protocol command may be associated with the relative vertical location of the user's hand in the frame of view. As such, no specialized peripherals (e.g., keyboards and soundboards) are required to generate and record sequences of music protocol commands using the DAW. Furthermore, the gesture music system leverages low-cost devices such as cameras and hardware that a user may already own (e.g., a smartphone) to generate music protocol commands. Therefore, the disclosed systems and methods solve the technical problem of requiring the use of specialized peripheral to generate music protocol commands in the technical field of digital artist workstations.

The gesture music system receives a frame of image data depicting a gesture performed by a user. The system inputs the frame to a first machine learning model configured to identify gestures shown in image data. The first machine learning model is trained on image data labeled with depicted gestures. The system receives, as output from the first machine learning model, an identification of the gesture. The system accesses a grid associated with the identified gesture. The grid includes a first axis corresponding to a first musical setting and a second axis corresponding to a second musical setting. The system determines a location of the gesture within the frame based on an overlay of the grid within the confines of the frame. The location corresponds to values for the first musical setting and the second musical setting. The system creates a music protocol command that corresponds to the values of the first musical setting and second musical setting. The system sends the music protocol command to a digital music workstation running at a user device. Sending the music protocol command causes the user device output a musical sound based on the first musical setting and second musical setting.

### BRIEF DESCRIPTION OF DRAWINGS

FIG. 1A is a block diagram of an overall system environment illustrating a data movement system, in accordance with one or more illustrative embodiments.

FIG. 1B illustrates an example system architecture for a gesture music system, in accordance with one or more illustrative embodiments.

FIG. 2A illustrates a frame of image data showing a first gesture, in accordance with one or more illustrative embodiments.

FIG. 2B illustrates a frame of image data with a hand performing a second gesture, in accordance with one or more illustrative embodiments.

FIG. 2C illustrates a frame of image data partitioned into a plurality of sub-grids, in accordance with one or more illustrative embodiments.

FIG. 3 is a high-level block diagram of a computer for implementing different entities illustrated in FIGS. 1A and 1B, in accordance with one or more illustrative embodiments.

FIG. 4 is a flowchart showing an exemplary process for identifying a gesture of a user using a machine learning model, generating a music protocol command based on the gesture, and sending the music protocol command to a user device, in accordance with one or more embodiments.

### DETAILED DESCRIPTION

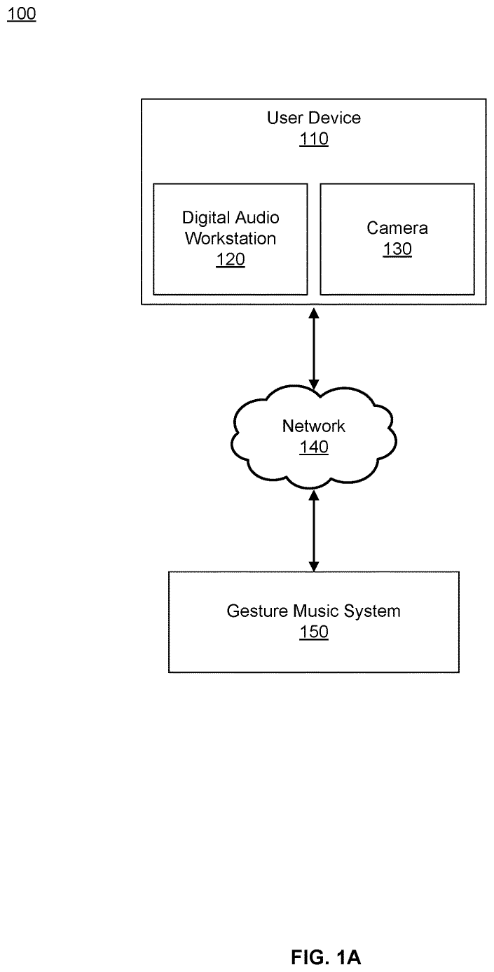

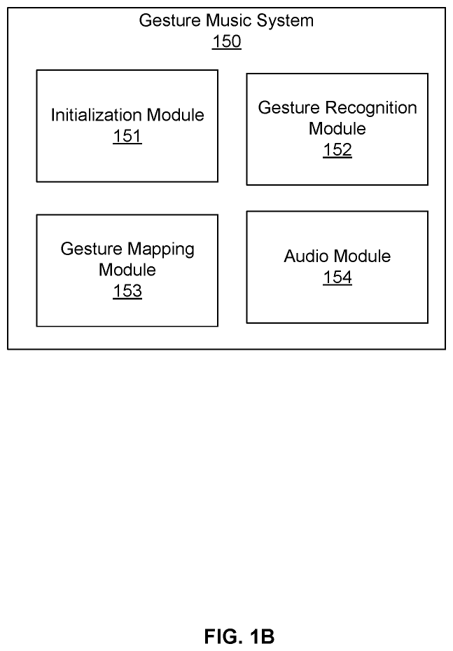

FIGS. 1-4 and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

The gesture music system described herein determines music protocol commands that control a digital audio workstation based on gestures made by a user. Though described herein in relation to music protocol commands, in some embodiments, the gesture music system may determine other commands to control a digital audio workstation. Examples of other commands may include Open Sound Control (OSC) commands, MIDI Polyphonic Expression (MPE) commands, Non-Registered Parameter Number (NRPN) commands, Control Chance (CC) commands, System Exclusive (Sysex) commands, Control Voltage/Gate (CV/Gate) commands, MIDI commands (Musical Instrument Digital Interface) and Open Sounds Protocol (SPP) commands. Further, in some embodiments, the gesture music system may use music protocol commands to control other types of digital workstations.

FIG. 1A is a block diagram of an overall system environment 100 illustrating a data movement system, according to an embodiment. As shown in FIG. 1A, the overall system environment 100 includes the gesture music system 150, user device 110 with a digital audio workstation (DAW) 120, a camera 130, and a network 140. Other embodiments may use more or fewer or different components than those illustrated in FIG. 1A. For example, the DAW 120 or camera 130 may be separate from the user device 110 or the gesture music system 150 may be partially or wholly integrated at the user device 110 (e.g., as a downloaded application, accessed via browser, or in any other manner). Functions of various modules and systems described herein can be implemented by other modules and/or systems than those described herein.

In some embodiments, a user device 110 (also referred to herein as a “client device”) is connected to the gesture music system 150 and may interact with the gesture music system 150 to record, edit, produce, or mix digital audio and music. A user device 110 is a computing system used by users to interact with the gesture music system 150. A user interacts with the gesture music system 150 using a user device 110 that executes client software, e.g., a web browser, client application, or plugin, to connect to the gesture music system 150. The user device 110 can include, for example, a mobile device (e.g., a laptop, a smart phone, or a tablet with operating systems such as ANDROID or APPLE IOS etc.), a desktop, a smart automobile or other vehicle, wearable device, a smart TV, and another network-capable device. A user may interact with the user device 110 to configure and interchange data with the gesture music system 150.

In some embodiments, a network 140 facilitates communication between the gesture music system 150 and other components of FIG. 1A. The network 140 is typically the Internet, but may be any network, including but not limited to a LAN, a MAN, a WAN, a mobile wired or wireless network, a cloud computing network, a private network, or a virtual private network.

The digital audio workstation (DAW) 120 is software designed for recording, editing, mixing, and producing audio. The DAW 120 may be at the user device 110 or connected to the user device 110 via the network 140 or a hardwire connection. The user can interact with the DAW 120 via the user device 110 to record multiple tracks of audio or music protocol commands, edit with precision, and apply a wide range of effects and processing tools. The DAW 120 may have features like multitrack recording, automation, virtual instruments, and support for third-party plugins. In some embodiments, the DAW 120 communicates with one or more external music workstations to record, edit, mix, or produce audio. In some embodiments, the DAW 120 and gesture music system 150 exchange music protocol commands through an application programming interface (API). For example, the gesture music system 150 may generate music protocol commands that are not directly compatible with a DAW 120. An intermediate API may convert or format music protocol commands to be compatible with the DAW 120 that a user intends to use.

The gesture music system 150 may include one or more modules or components that are used to implement the methods and system described below. Other features of the gesture music system 150, such as firewalls, load balancers, authentication servers, application servers, failover servers, and site management tools are not shown so as to more clearly illustrate the features of the gesture music system 150. The illustrated components of the gesture music system 150 can be implemented as single or multiple components of software or hardware. In general, functions described in one embodiment as being performed by components of the gesture music system 150 can also be performed by one or more user devices 110 or other systems in other embodiments if appropriate. Further details about gesture music system 150 are disclosed below with respect to FIG. 1A and beyond.

FIG. 1B illustrates an example system architecture for a gesture music system 150, in accordance with one or more illustrative embodiments. Gesture music system 150 includes an initialization module 151, a gesture recognition module 152, a gesture mapping module 153, and an audio module 154. Alternative embodiments may include more, fewer, or different components from those illustrated in FIG. 1B and the components may be arranged or configured differently from the embodiment illustrated in FIG. 1B in any manner that achieves the functionality disclosed herein.

The gesture music system 150 is configured to control the DAW 120 based on gestures and movements made by a user. The gesture music system 150 receives image data from a camera 130 of the user device 110. The gesture music system 150 trains a recognition model, which may be a machine learning model, to determine real-time gestures depicted in image data and output musical commands based on those gestures. The recognition model may be personalized to the user of the user device executing the DAW 120. In particular, the recognition model may be trained on image data of the user captured during an initialization process. The gesture music system 150 determines a grid to use for each detected gesture. The gesture music system 150 determines the location of the gesture within the frame of image data and maps the location to the grid. The location of the gesture on the grid is indicative of a value to use corresponding to each axis of the grid—for example, which musical note to play and at what volume for an x-axis corresponding to musical notes and a y-axis corresponding to volume. The gesture music system creates music protocol commands based on the values. The gesture music system 150 may access local storage that maps outputs and settings to music protocol commands and create a music protocol command that corresponds to the output and settings of a gesture. Upon creating the music protocol command, the gesture music system 150 outputs the command to the DAW 120.

The user may establish preferences such as personalized DAW 120 settings corresponding to gestures and participate in an initialization process for establishing these preferences based on activity of the initialization module 151. Initialization module 151 is configured to receive data (e.g., image data) associated with a user of the gesture music system 150 to configure a user profile for the user during the initialization process. Personalized DAW 120 settings might include selecting which music protocol commands are associated with particular gestures (e.g., a clenched fist may be associated with an instrument change). For the purposes of the gesture music system 150, a gesture is described as the pose of one or more of the user's hands in a frame of image data. Gestures are classified based on the distances between key points (e.g., associated with joints and fingers of one or more hands) shown in the image data. For example, a hand depicted in image data may have a number of key points (e.g., a constellation) mapped to portions of the hand. A coarse constellation mapped to a hand might include points at each joint of the hand, including the joints of each finger, and points along the perimeter of the palm.

In some embodiments, a gesture may be classified as a dynamic gesture. A dynamic gesture includes one or more temporal relationships between frames containing gestures identified using key points. For example, a tapping motion (as if a user was tapping a virtual screen coplanar with the frame of the capture window) may be captured as a dynamic gesture. While the pose of the hand, as described by its key points, may not vary substantially enough to be classified as a first gesture and a second gesture, the temporal relationship of frames capturing the motion may be associated with a dynamic gesture. Dynamic gestures may be captured during the initialization process and mapped to musical protocol commands and settings of the DAW 120.

The initialization process may involve causing the user device 110 to instruct the user to perform a series of gestures and capture the user performing the gestures. For example, the gesture music system 150 may cause the user device 110 to output audio or visual data guiding the user to perform the series of gestures (e.g., using a wizard that prompts the user for various inputs). The image data may be labeled with an identifier of the gesture and distances between key points of one or more hands shown in the image data. For input image data, the recognition model may output an identifier of a gesture depicted in the image data and distance between key points of the hand(s) that is making the gesture.

During the initialization process, the initialization module 151 may also receive interactions from the user indicative of types of outputs and settings of the DAW 120 to associate each gesture with. The type of output indicates what the effect of the gesture will be when a corresponding music protocol command is sent to the DAW 120 and corresponds to a status byte of a music protocol command. Example outputs include playing a note, controlling parameters (e.g., volume, pan, sustain pedal, etc.), changing instrument, bending pitch, and the like. Settings may include note, chord, velocity, volume, channel, value, least significant byte, most significant byte, and other parameters. The user may also select gestures and corresponding types of outputs and settings while interacting with the DAW 120 after initialization and may do so via one or more inputs to the user device 110, including voice commands. Use of voice commands with the gesture music system 150 is further described below. The gesture music system 150 stores types of outputs and settings in association with the identifiers of gestures in a local datastore.

Labeled training data for the recognition model may correspond to a portion of image data depicting the gesture, key points of the hand(s) making the gesture, or both. By training the recognition model with image data depicting gestures and/or key points of gestures, the model may be more robust in identifying gestures based on image data. Multiple types of training data inputs during initialization process may enable the recognition model to correctly identify a gesture based on key points of the gesture if the model fails to classify the gesture using image data depicting the gesture, and vice versa.

Initialization module 151 may train the recognition model on the labeled image data, such that the recognition model may analyze the distances between key points of the user's hand(s) that correspond with particular gestures the user makes and determine distances between key points shown in newly received in image data to distinguish between different gestures. Further, the recognition model may be trained to store and recognize user-specific gestures. For instance, the user may record image data of a hand position or movement that the user wants the gesture music system to recognize as a gesture, and the gesture music system 150 trains the recognition model on the recorded image data.

Initialization module 151 may access stored information (e.g., stored in the network 140 or a local datastore) describing a user's history or preferences. The history of the user may include approximate measurements between key points for the user's hands. User preferences may include a list of gestures associated with the user. For example, the user may define new gestures that correspond to a desired music protocol command. In another example, the user may reassign an existing gesture (e.g., a pinching gesture) from a default music protocol command to a desired music protocol command. For example, some or all initialization steps that would be presented to the user by the initialization module 151 may be bypassed by accessing stored initialization data associated with the user. The user profile configured by the initialization module 151 may be accessed by other modules of the gesture music system 150 (e.g., the gesture recognition module 152 or gesture mapping module 153) to ensure that the user's gestures are correctly mapped to the music protocol commands that the user intends to generate.

As the gesture music system 150 receives image data depicting the user, gesture recognition module 152 applies the recognition model to each frame of the image data and receives an identifier of a gesture as output from the recognition model (e.g., the recognition model training by the initialization module 151). The process of identifying gestures essentially captures the intentions of the user, similar to the role of a keyboard or other input device. When the user is ready to gesturally generate or record music protocol commands, gesture recognition module 152 is used to identify gestures depicted by the user in frames of image data.

Gesture recognition module 152 receives image data from the user device 110 as the user performs gestures to edit or create content using the DAW 120. In some embodiments, gesture recognition module 152 uses computer vision techniques on the image data. Gesture recognition module 152 may apply the recognition model to each frame of the image data and receive an identifier of a gesture as output from the recognition model. Training the recognition model (e.g., during the initialization process) allows gesture recognition module 152 to detect whether a gesture is depicted in image data and identify the detected gesture (e.g., classifying gestures detected in image data).

In some embodiments, the recognition model identifies a gesture depicted in the image data based on the portion of the image data (e.g., a bounding box) depicting the gesture. As described during the initialization process, the recognition model may be trained to classify gestures based on labeled training image data that depicts the gestures. If the image data depicts a user's gesture that mimics one of the gestures captured in the initialization process, the recognition model outputs an identified gesture. As such, the recognition model can detect and identify gestures without the use of key points.

In some embodiments, the recognition model receives image data depicting a gesture and generates key points (e.g., a constellation) for the gesture. As described during the initialization process, the recognition model may be trained to classify gestures based on training data labeled with the gestures and key points generated for the gestures. The recognition model determines whether the key points generated for the gesture depicted in the image data correspond to key points for a labeled gesture captured during the initialization process. Upon classifying the generated key points for the input image data, the recognition model outputs an identified gesture. As such, the recognition model can detect and identify gestures based on key points instead of image data. In some embodiments, the recognition model predicts gestures using both image data depicting gestures and key points generated for gestures in the image data. The gesture music system 150 may store the distances between key points of the user's hands in association with the identifier and the corresponding image data in a local datastore.

Gesture recognition module 152 receives the identifier of the gesture from the recognition model. In some embodiments, such as for a new gesture the recognition model has not been trained to detect, the gesture music system may request an identifier for the gesture via a prompt to the user at the user device 110. The gesture music system 150 stores distances between key points of the hand performing the gesture output from the recognition model and stores the distances in association with the identifier for the gesture received via the prompt.

The gesture music system 150 uses the relative location of identified gestures depicted in image data to capture control inputs for commands generated for the DAW 120. For example, gesture mapping module 153 may determine a location for the identified gesture on a grid overlay for the capture window of the image data. By assigning the gesture to a location (e.g., a two-dimensional coordinate for a grid having two axes), the location can be assigned to control inputs of a command. In a grid having two axes, one axis may correspond to a note and the other may correspond to a volume level. As such, the gesture music system has captured an identified gesture and an approximate location of the gesture within the capture window.

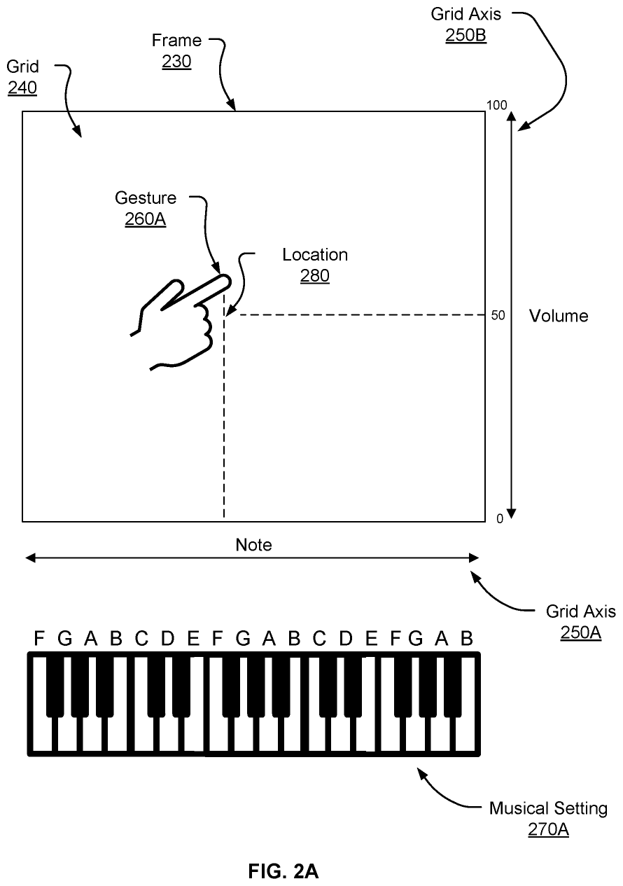

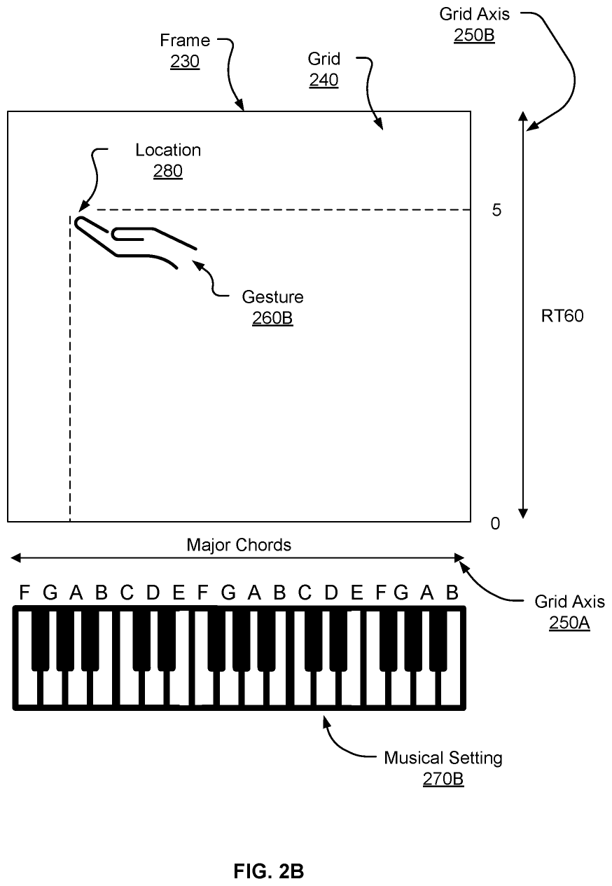

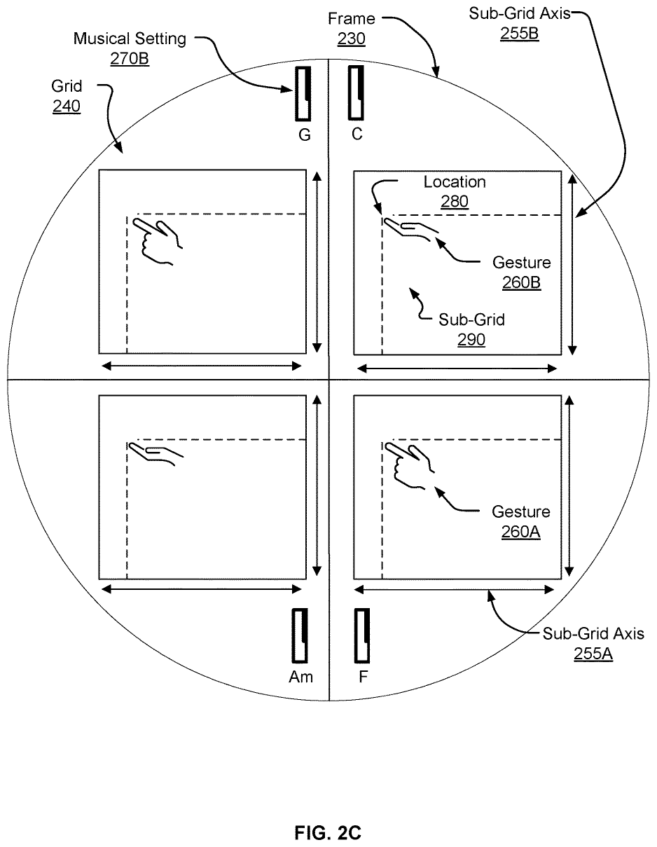

Gesture mapping module 153 determines a grid to use for each identified gesture received from gesture recognition module 152. An example of a grid generated for a frame (e.g., generated by gesture mapping module 153) is illustrated in FIG. 2A. The grid 240 may be sized to overlay onto the capture window of each frame 230. The capture window is the portion of the environment that is captured in each frame 230 of the image data. In some embodiments, the size of the overlay is based on the initialization process for the user (e.g., using the initialization module 151). For example, data describing the portion of the capture window frame 230 in which the user performed the instructed series of gestures may be accessed from a datastore associated with the user (e.g., on the user device 110). This data may indicate a portion of the capture window in which the user prefers to make gestures for generating music protocol commands. For example, the user may have a limited range of motion which limits their ability to utilize the entire capture window in a given position. Gesture mapping module 153 may generate an overlay of the grid 240 based on this stored data from an initialization process.

The grid 240 may include a first grid axis 250A and a second grid axis 250B (e.g., an x-axis representing a first musical setting and a y-axis representing a second musical setting). For example, a pointing gesture 260A may correspond to changing volume level (e.g., the y-axis of the grid) of a channel (e.g., the x-axis of the grid) and a clenched fist may correspond to playing a note (e.g., the x-axis) at a particular velocity (e.g., the y-axis). An example of a grid 240 for a frame 230 generated for an alternative gesture 260B, first musical setting 270A, and second musical setting 270B is illustrated in FIG. 2B. In some embodiments, the grid 240 further includes a third grid axis 250 (e.g., a z-axis representative of a third musical setting). Returning to the previous example, an open palm gesture 260 moving towards and away from the user device 110 in the image data may represent changing chords (e.g., the z-axis) at a particular channel and volume.

In some embodiments, the grid 240 is partitioned into a plurality of sub-grids 290. An example of a grid 240 portioned into a plurality of sub-grids 290 is illustrated in FIG. 2C. Each sub-grid 290 may include a first sub-grid axis 255A and a second sub-grid axis 255B associated with a first musical setting 270 and a second musical setting 270 (e.g., volume, or a range of music notes).

In some embodiments, the entire portion of the frame 230 partitioned by a sub-grid 290 is associated with a third musical setting 270B. For example, any gesture 260 mapped to a sub-grid 290 associated with a third musical setting 270B will be mapped to a music protocol command assigned to the third musical setting 270. The location 280 of the gesture 260 relative to the first sub-grid axis 255, the second sub-grid axis 255, and the partitioned sub-grid 290 may generate, for example, a G chord at 60% volume at a reverb setting of 3. While the example of a grid 240 partitioned into a plurality of sub-grids 290 shown in FIG. 2C depicts four sub-grid partitions, the grid 240 may be partitioned into any number of sub-grids 290, each associated with a musical setting 270.

Gesture mapping module 153 determines a location 280 of the gesture 260 within the frame 230 and maps the location 280 to the grid 240 within the confines of the frame 230. The first distance from the gesture 260 from the origin of each grid axis 250 represents the location 280 of the gesture 260 on the grid 240, relative to one or more grid axes 250 (e.g., a first grid axis and a second grid axis). The location 280 is indicative of a value to use corresponding to each grid axis 250, for example, which musical note to play and at what volume for an x-axis corresponding to musical notes and a y-axis corresponding to volume. Put another way, a location 280 on the grid 240 that the gesture 260 corresponds to is indicative of which value to use for the musical setting 270 of the corresponding grid axis 250. Gesture mapping module 153 determines the value associated with each grid axis 250 based on the location 280 of the gesture 260 on the grid 240.

Gesture mapping module 153 may access a local datastore to retrieve settings associated with the identifier of the detected gesture 260. In some embodiments, the settings also include an indication of whether to use the setting for the x-axis or y-axis, as prescribed by the user during storage of the settings in association with the identifier of the detected gesture 260. In some embodiments, gesture mapping module 153 may receive real-time audio data indicative of settings to use for the grid 240 (e.g., a user verbally requests to change the musical setting for a grid axis from volume to reverb).

Based on the identified gesture and control inputs, the audio module 154 generates a music protocol command and one or more control inputs for that command based on a gesture and its location within the frame. For example, the audio module 154 may generate a command for the gesture and its location based on data from the initialization process (e.g., a user-defined list that associates gestures with commands).

Audio module 154 creates music protocol commands based on values output from the gesture recognition module 152 and gesture mapping module 153. Audio module 154 may access a local datastore that maps outputs and settings to music protocol commands and create a music protocol command that corresponds to the output and settings of a gesture. Returning to the example with the x-axis corresponding to musical notes and the y-axis corresponding to volume, gesture mapping module 153 system may determine that the location of a corresponding gesture indicates the note “Middle C” and a volume of 100 and the output associated with the gesture is to turn the note on. Audio module 154 may convert this into the corresponding music protocol command of “144 60 100,” which the gesture music system sends to the DAW 120, thus causing the user device executing the DAW 120 to output the note at the volume.

In some embodiments, audio module 154 determines music protocol commands by accessing a data structure populated by modules of the gesture music system 150. Musical protocol commands may correspond to a data structure containing at least a value associated with the gesture identified by the gesture recognition module 152 and one or more values associated with the location of the gesture on the grid, as determined by the gesture mapping module 153. For example, audio module 154 may access an entry in the data structure (e.g., {“gesture_type”: “clenched fist”, “gridAxis_1”: “50”, “gridAxis_2”: “F”}) and output a music protocol command based on values from the entry.

Audio module 154 may determine music protocol commands based on a gesture being shown in a first frame but not a subsequent frame of the image data. In these instances, audio module 154 may select an output that corresponds to a status byte of a music protocol command to reset or turn off the musical setting of the gesture. So, for example, when the gesture that indicates the note “Middle C” and volume 100 is not shown in a subsequent frame, the gesture music system may determine a music protocol command that indicates to stop playing the note and send the music protocol command to the DAW 120 (e.g., music protocol command “128 60 0”).

In some embodiments, the gesture music system 150 receives voice commands captured at the user device 110. In some embodiments, the gesture music system 150 may convert the audio (e.g., using the audio module 154) into text. Audio module 154 may create a prompt including the audio and a request for a music protocol command corresponding to the audio and input the prompt to a generative language model. The generative language model may determine an output and musical setting described by the user in the audio and convert the output and musical setting into a music protocol command that is sent to the DAW 120. Thus, the user can provide instructions such as “go back,” “record,” “stop,” and the like to the gesture music system 150 to interact with the DAW 120.

In some embodiments, the audio module 154 applies a suggestion model, which is a machine learning model trained on sounds samples labeled with music theory information. The sounds samples may be audio data or sets of music protocol commands. The music theory information may indicate sequences of musical settings or parameters related to music theory that are emblemized by the associated sound sample. For example, a pop song may be labeled with the chord progression “C-G-Am-F,” commonly called the “Axis of Awesome” in music theory and is commonly used in pop music. Once trained, the suggestion model may receive sounds samples captured at the user device 110 or determined based on music protocol commands sent to the DAW 120 and output suggestions for the sound samples based on music theory. The suggestions may be converted to music protocol commands and sent to the DAW 120 or may be output as textual information for display at the user device 110. In some embodiments, the suggestion model may receive voice commands indicative of what a user wants output and make suggestions based on associated music theory information.

In some embodiments, the audio module 154 applies a recommendation model, which is a machine learning model trained on music protocol commands creates by the gesture music system 150 based on gestures made by the user. Based on training, the recommendation model may learn patterns in how the user interacts with the DAW 120 and creates and edits music such that the recommendation model may receive music protocol commands being entered in real-time based on the user's gestures and output recommended music protocol commands. The recommended music protocol commands may be output to the DAW 120 for implementation or may be output to the user device 110 for display to the user, such that the user can select recommended music protocol commands as desired.

Audio module 154 transmits the music protocol command to the DAW 120 running at the user device 110. The sending of the music protocol command causes the user device 110 to output a musical sound based on, for example, the first musical setting and second musical setting. Audio module 154 creates and transmits a sequence of music protocol commands corresponding to a sequence of frames, such that transmission of the music protocol commands causes visual and audio output to be presented in real-time with the corresponding frames.

Audio module 154 transmits the music protocol command to the DAW 120 running at the user device 110. The transmission of the music protocol command causes the user device 110 to output a musical sound based on the first musical setting and second musical setting determined from the gesture location on the grid. The audio module 154 may transmit music protocol commands through various communication protocols, including direct software integration when the gesture music system 150 is implemented as a plugin or extension within the DAW 120, or through network communication when the gesture music system 150 operates as a separate application. In some embodiments, the audio module 154 may buffer multiple music protocol commands to minimize latency between gesture recognition and audio output. In some embodiments, the DAW 120 processes one or more music protocol commands according to current instrument settings, effects chain, and audio configuration, resulting in the generation and playback of the corresponding musical sound through the audio output system of the user device 110.

In various embodiments, a wide variety of machine learning techniques may be used for the machine-learning model described above. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN), long short-term memory networks (LSTM), transformers, linear recurrent neural networks such as Mamba may also be used.

In various embodiments, the training techniques for a machine learning model may be supervised, semi-supervised, or unsupervised. In supervised learning, the machine learning models may be trained with a set of training samples that are labeled.

By way of example, the training set may include multiple past image data labeled with known outcomes. Each training sample in the training set may correspond to a past and the corresponding outcome may serve as the label for the sample. A training sample may be represented as a feature vector that includes multiple dimensions. Each dimension may include data of a feature, which may be a quantized value of an attribute that describes the past record.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In various embodiments, the error rate may be measured as cross-entropy loss, L1 loss (e.g., the sum of absolute differences between the predicted values and the actual value), L2 loss (e.g., the sum of squared distances).

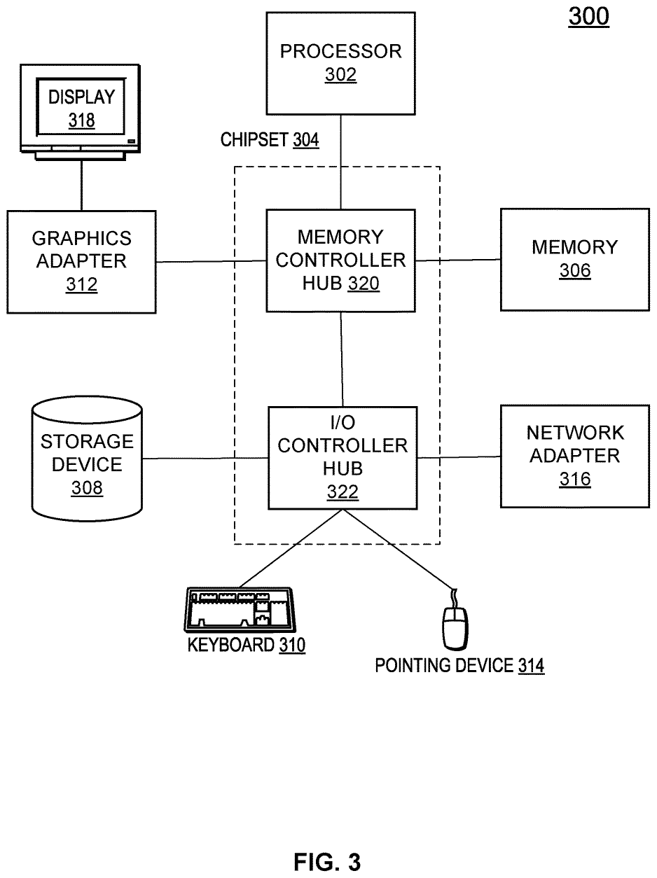

FIG. 3 is a high-level block diagram of a computer 300 for implementing different entities illustrated in FIGS. 1A and 1B. The computer 300 includes at least one processor 302 coupled to a chipset 304. Also coupled to the chipset 304 are a memory 306, a storage device 308, a keyboard 310, a graphics adapter 312, a pointing device 314, and a network adapter 316. A display 318 is coupled to the graphics adapter 312. In one embodiment, the functionality of the chipset 304 is provided by a memory controller hub 320 and an I/O controller hub 322. In another embodiment, the memory 306 is coupled directly to the processor 302 instead of the chipset 304.

The storage device 308 is any non-transitory computer-readable storage medium, such as a hard drive, compact disk read-only memory (CD-ROM), DVD, or a solid-state memory device. The memory 306 holds instructions and data used by the processor 302. The pointing device 314 may be a mouse, track ball, or other type of pointing device, and is used in combination with the keyboard 310 to input data into the computer system 300. The graphics adapter 312 displays images and other information on the display 318. The network adapter 316 couples the computer system 300 to the network.

As is known in the art, a computer 300 can have different and/or other components than those shown in FIG. 3. In addition, the computer 300 can lack certain illustrated components. For example, the computer acting as the data movement system can be formed of multiple blade servers linked together into one or more distributed systems and lack components such as keyboards and displays. Moreover, the storage device 308 can be local and/or remote from the computer 300 (such as embodied within a storage area network (SAN)).

As is known in the art, the computer 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 308, loaded into the memory 306, and executed by the processor 302.

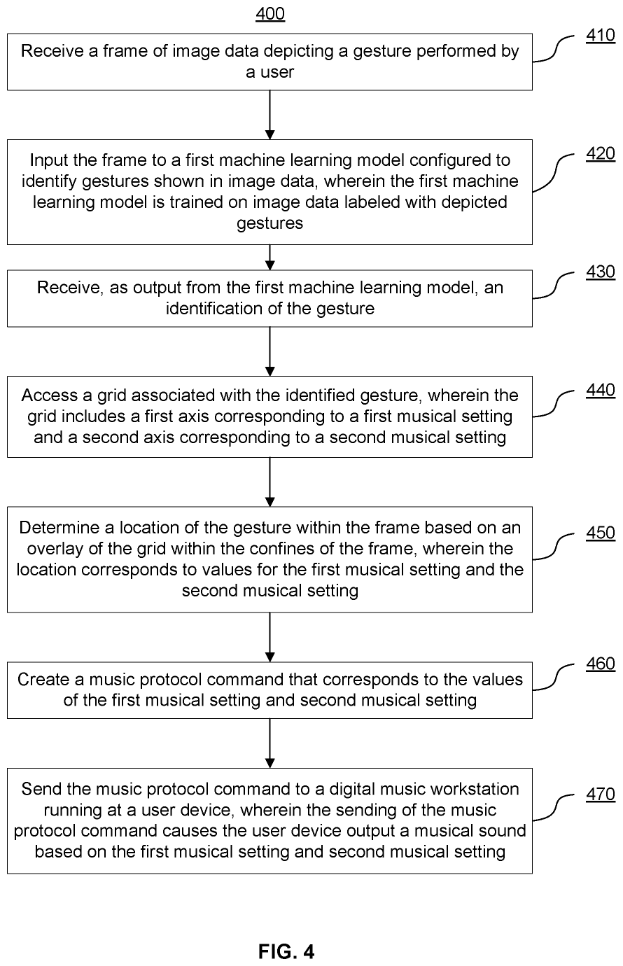

FIG. 4 is a flowchart showing an exemplary process 400 for identifying a gesture of a user using a machine learning model, generating a music protocol command based on the gesture, and sending the music protocol command to a user device, in accordance with one or more embodiments. As depicted in FIG. 4, process 400 may be run based on one or more processors executing instructions stored in a non-transitory computer-readable medium. Process 400 may begin with gesture music system 150 receiving 410 a frame of image data depicting a gesture performed by a user (e.g., using initialization module 151). Gesture music system 150 inputs 520 the frame to a first machine learning model configured to identify gestures shown in image data (e.g., using gesture recognition module 152), wherein the first machine learning model is trained on image data labeled with depicted gestures and receives 530, as output from the first machine learning model (e.g., using gesture recognition module 152), an identification of the gesture. Upon receiving the identification of the gesture, gesture music system 150 accesses 440 a grid associated with the identified gesture (e.g., using gesture mapping module 153), wherein the grid includes a first axis corresponding to a first musical setting and a second axis corresponding to a second musical setting. Gesture music system 150 determines 450 a location of the gesture within the frame based on an overlay of the grid within the confines of the frame (e.g., using gesture mapping module 153), wherein the location corresponds to values for the first musical setting and the second musical setting. Gesture music system 150 creates 460 a music protocol command (e.g., using audio module 154) that corresponds to the values of the first musical setting and second musical setting and sends 470 the music protocol command (e.g., using audio module 154) to a digital music workstation running at a user device, wherein the sending of the music protocol command causes the user device output a musical sound based on the first musical setting and second musical setting.

### ALTERNATIVE EMBODIMENTS

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative designs for a unified communication interface providing various communication services. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A method comprising:
receiving a frame of image data depicting a gesture performed by a user;
inputting the frame to a first machine learning model configured to identify gestures shown in image data, wherein the first machine learning model is trained on image data labeled with depicted gestures;
receiving, as output from the first machine learning model, an identification of the gesture;
accessing a grid associated with the identified gesture, wherein the grid includes a first axis corresponding to a first musical setting and a second axis corresponding to a second musical setting;
determining a location of the gesture within the frame based on an overlay of the grid within the confines of the frame, wherein the location corresponds to values for the first musical setting and the second musical setting;
creating a music protocol command that corresponds to the values of the first musical setting and second musical setting; and
sending the music protocol command to a digital music workstation running at a user device, wherein the sending of the music protocol command causes the user device output a musical sound based on the first musical setting and second musical setting.

2. The method of claim 1, wherein the first machine learning model is trained using an initialization process comprising:
instructing the user, using the user device, to perform a series of gestures;
capturing image data of the series of gestures for the user;
measuring distances between joints of one or more hands shown in the image data; and
associating a plurality of labels with the image data, the labels comprising an identifier for each gesture and the measured distances.

3. The method of claim 2, wherein the overlay of the grid within the confines of the frame is generated based on the series of gestures performed by the user during the initialization process, and wherein the series of gestures performed by the user indicates a preferred portion of the frame to perform gestures.

4. The method of claim 1, wherein the first machine learning model is configured to identify temporal relationships between frames in a series of frames from image data, wherein the temporal relationships describe a series of gestures captured in the series of frames.

5. The method of claim 4, further comprising:
for each frame of the series of frames, creating a respective music protocol command that corresponds to the identified gesture in the frame and the location of the identified gesture within the frame based on an overlay of the grid within the confines of the frame.

6. The method of claim 1, wherein the grid associated with the identified gesture is partitioned into a plurality of sub-grids, and wherein each sub-grid includes a first sub-grid axis corresponding to the first musical setting and a second sub-grid axis corresponding to the second musical setting.

7. The method of claim 6, further comprising:
determining the location of the gesture within the frame based on an overlay of the sub-grid within the confines of the frame, wherein the location corresponds to a third musical value associated with the sub-grid; and
creating a music protocol command that corresponds to the values of the third musical value.

8. The method of claim 1, further comprising:
receiving interactions from the user indicative of settings of the digital music workstation to associate each gesture with; and
storing the settings in association with identifiers of gestures in a local datastore.

9. A non-transitory computer-readable medium comprising memory with instructions encoded thereon that, when executed by one or more processors, cause the one or more processors to perform operations, the instructions comprising instructions to:
receive a frame of image data depicting a gesture performed by a user;
input the frame to a first machine learning model configured to identify gestures shown in image data, wherein the first machine learning model is trained on image data labeled with depicted gestures;
receive, as output from the first machine learning model, an identification of the gesture;
access a grid associated with the identified gesture, wherein the grid includes a first axis corresponding to a first musical setting and a second axis corresponding to a second musical setting;
determine a location of the gesture within the frame based on an overlay of the grid within the confines of the frame, wherein the location corresponds to values for the first musical setting and the second musical setting;
create a music protocol command that corresponds to the values of the first musical setting and second musical setting; and
send the music protocol command to a digital music workstation running at a user device, wherein the sending of the music protocol command causes the user device output a musical sound based on the first musical setting and second musical setting.

10. The non-transitory computer-readable medium of claim 9, wherein the first machine learning model is trained using an initialization process, the instructions further comprising instructions to:
receive a frame of image data depicting a gesture performed by a user;
instruct the user, using the user device, to perform a series of gestures;
capture image data of the series of gestures for the user;
measure distances between joints of one or more hands shown in the image data; and
associate a plurality of labels with the image data, the labels comprising an identifier for each gesture and the measured distances.

11. The non-transitory computer-readable medium of claim 10, wherein the overlay of the grid within the confines of the frame is generated based on the series of gestures performed by the user during the initialization process, wherein the series of gestures performed by the user indicates a preferred portion of the frame to perform gestures.

12. The non-transitory computer-readable medium of claim 9, wherein the first machine learning model is configured to identify temporal relationships between frames in a series of frames from image data, and wherein the temporal relationships describe a series of gestures captured in the series of frames.

13. The non-transitory computer-readable medium of claim 12, the instructions further comprising instructions to:
for each frame of the series of frames, create a respective music protocol command that corresponds to the identified gesture in the frame and the location of the identified gesture within the frame based on an overlay of the grid within the confines of the frame.

14. The non-transitory computer-readable medium of claim 9, wherein the grid associated with the identified gesture is partitioned into a plurality of sub-grids, and wherein each sub-grid includes a first sub-grid axis corresponding to the first musical setting and a second sub-grid axis corresponding to the second musical setting.

15. The non-transitory computer-readable medium of claim 14, the instructions further comprising instructions to:
determine the location of the gesture within the frame based on an overlay of the sub-grid within the confines of the frame, wherein the location corresponds to a third musical value associated with the sub-grid; and
create a music protocol command that corresponds to the values of the third musical value.

16. The non-transitory computer-readable medium of claim 9, the instructions further comprising instructions to:
receive interactions from the user indicative of settings of the digital music workstation to associate each gesture with; and
store the settings in association with identifiers of gestures in a local datastore.

17. A system comprising:
memory with instructions encoded thereon; and
one or more processors that, when executing the instructions, are caused to perform operations comprising:
receiving a frame of image data depicting a gesture performed by a user;
inputting the frame to a first machine learning model configured to identify gestures shown in image data, wherein the first machine learning model is trained on image data labeled with depicted gestures;
receiving, as output from the first machine learning model, an identification of the gesture;
accessing a grid associated with the identified gesture, wherein the grid includes a first axis corresponding to a first musical setting and a second axis corresponding to a second musical setting;
determining a location of the gesture within the frame based on an overlay of the grid within the confines of the frame, wherein the location corresponds to values for the first musical setting and the second musical setting;
creating a music protocol command that corresponds to the values of the first musical setting and second musical setting; and
sending the music protocol command to a digital music workstation running at a user device, wherein the sending of the music protocol command causes the user device output a musical sound based on the first musical setting and second musical setting.

18. The system of claim 17, wherein the first machine learning model is trained using an initialization process, the operations further comprising:
instructing the user, using the user device, to perform a series of gestures;
capturing image data of the series of gestures for the user;
measuring distances between joints of one or more hands shown in the image data; and
associating a plurality of labels with the image data, the labels comprising an identifier for each gesture and the measured distances.

19. The system of claim 18, wherein the overlay of the grid within the confines of the frame is generated based on the series of gestures performed by the user during the initialization process, wherein the series of gestures performed by the user indicates a preferred portion of the frame to perform gestures.

20. The system of claim 17, wherein the first machine learning model is configured to identify temporal relationships between frames in a series of frames from image data, wherein the temporal relationships describe a series of gestures captured in the series of frames.
